(19) United States
(12) Patent Application Publication
(10) Pub. No.: US 2023/0181399 A1
(43) Pub. Date: Jun. 15, 2023

(54) PATIENT ISOLATION UNIT FOR PATHOGEN CONTAINMENT DURING MEDICAL IMAGING PROCEDURES

(71) Applicant: General Electric Company, Schenectady, NY (US)

(72) Inventors: Bruno Kristiaan Bernard De Man, Clifton Park, NY (US); Paul Francis FitzGerald, Schenectady, NY (US); Stephen Lorenco Araujo, Niskayuna, NY (US); Uwe Wiedmann, Clifton Park, NY (US); Michael James Rishel, Mechanicville, NY (US); Ross Christopher Stalter, Hartland, WI (US)

(21) Appl. No.: 17/967,665

(22) PCT Filed: Apr. 19, 2021
(86) PCT No.: PCT/US2021/028006

§ 371 Date: Oct. 17, 2022

Related U.S. Application Data
(60) Provisional application No. 63/011,481, filed on Apr. 17, 2020.

(51) Int. Cl. A61G 10/02; A61G 10/00

(52) U.S. Cl. CPC A61G 10/02; A61G 10/005; A61G 2210/50

(57) ABSTRACT

Systems are provided for a patient isolation unit for use with a medical imaging system includes an enclosure comprised of a pathogen impermeable material compatible with one or more imaging systems. The enclosure includes a base, a first end wall coupled to a first end of the base, a second end wall coupled to a second end of the base, and a cover coupled to a first side of the base, second side of the base, the first end wall and the second end wall for substantially enclosing a patient therein. In another exemplary embodiment, a patient isolation unit for use with a medical imaging system includes a head enclosure comprised of a pathogen impermeable material and a body enclosure coupled to the head enclosure and comprised of a pathogen impermeable material.

### CROSS-REFERENCE TO RELATED APPLICATIONS

This application claims the benefit of and priority to U.S. Provisional Application No. 63/011,481, filed on Apr. 17, 2020, and to International Application No. PCT/US2021/028006, filed on Apr. 19, 2021, the disclosures of which are incorporated herein by reference in their entirety.

### BACKGROUND

The present disclosure relates to a patient isolation unit and its use, and more particularly to a patient isolation unit for use during medical imaging procedures.

In terms of advancements in technology, various non-invasive diagnostic scanning and imaging techniques are now utilized by a wide variety of medical imaging systems to aid diagnosis and patient care. Exposure and spread of pathogens are of great concern when such medical imaging equipment or systems are utilized in conjunction with patients having one or more infectious diseases. As used herein, the term “pathogen” or “pathogens” refers to any microscopic organism capable of causing disease or infection in a human being. These include bacteria, viruses, spores, and fungi. Contamination of medical imaging equipment and collateral equipment in the imaging room or suite, and the general exposure to healthcare professionals within the imaging suite with these pathogens presents a great risk to healthcare providers, including imaging operators, technologists, nursing aids, nurses, physicians, and field engineers when operating and/or servicing the imaging equipment. In addition, repeat usage of medical imaging equipment and the imaging suite may present a risk to subsequent users and healthcare professionals. In some instances, pathogens could be drawn into the equipment’s air intake and circulated around the room by the cooling air exhaust fans. Similarly, exposure to a non-infectious patient by a contaminated imaging suite is of concern. The need to clean imaging equipment and imaging rooms to limit hospital acquired infections presents a great concern, increases the burden on healthcare professionals, and dramatically impacts patient throughput.

It would therefore be desirable to provide an enclosure or isolation unit that isolates a patient from the imaging systems and/or equipment and the imaging room or suite that addresses the above issues.

### SUMMARY

This summary introduces concepts that are described in more detail in the detailed description. It should not be used to identify essential features of the claimed subject matter, nor to limit the scope of the claimed subject matter.

In an aspect, a patient isolation unit for use with a medical imaging system includes an enclosure comprised of a pathogen impermeable material compatible with one or more imaging systems, and an air filtration system coupled to the enclosure. The air filtration system includes an inlet to supply filtered air to an interior of the enclosure and an outlet to exhaust filtered air to an exterior of the enclosure.

In another aspect, a patient isolation unit for use with a medical imaging system includes a base, a first end wall coupled to a first end of the base, a second end wall coupled to a second end of the base, and a cover coupled to a first side of the base, second side of the base, the first end wall and the second end wall for substantially enclosing a patient therein between the base, the first end wall, and the second end wall for use on a medical imaging system.

In yet another aspect, a patient isolation unit for use with a medical imaging system includes a head enclosure comprised of a pathogen impermeable material compatible with one or more imaging systems and a body enclosure coupled to the head enclosure and comprised of a pathogen impermeable material compatible with one or more imaging systems.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The features, aspects, and advantages of the present disclosure will become better understood when the following detailed description is read with reference to the accompanying drawings, wherein:

FIG. 1 is a schematic perspective view of an embodiment of a patient isolation unit coupled to and positioned relative to a medical imaging system;

FIG. 2 is a schematic perspective view of another embodiment of a patient isolation unit coupled to and positioned relative to a medical imaging system;

FIG. 3 is an exploded schematic perspective view of yet another embodiment of a patient isolation unit;

FIG. 4 is a schematic view of another embodiment of a patient isolation unit;

FIG. 5 is a schematic perspective view of the embodiment of the patient isolation unit of FIG. 4 in an assembled state;

FIG. 6 is a schematic top view of the embodiment of the patient isolation unit of FIG. 5;

FIG. 7 is a schematic view of another embodiment of a patient isolation unit;

FIG. 8 is a schematic top view of the embodiment of the patient isolation unit of FIG. 7;

FIG. 9 is a schematic perspective view of another embodiment of a patient isolation unit coupled to and positioned relative to a medical imaging system;

FIG. 10 is a schematic perspective view of another embodiment of a patient isolation unit coupled to and positioned relative to a medical imaging system; and

FIG. 11 is a schematic perspective view of yet another embodiment of a patient isolation unit.

### DETAILED DESCRIPTION

Embodiments of the present disclosure will now be described, by way of example, with reference to the Figures, in which a patient isolation unit is positioned relative to a medical imaging system and coupled to the medical imaging system to isolate an infectious diseased patents from a medical facility imaging room and medical imaging equipment by enclosing the patient within the patient isolation unit that is specifically intended for use with medical imaging equipment.

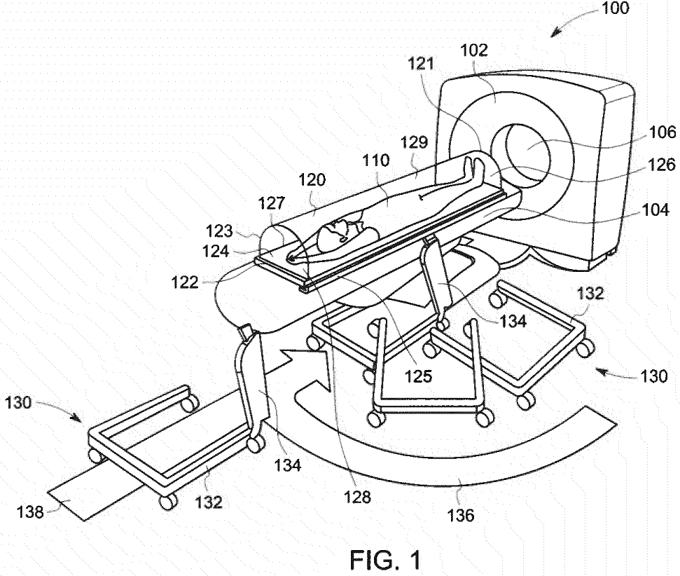

FIG. 1 illustrates an exemplary computed tomography (CT) imaging system 100 configured for CT imaging or scanning. Particularly, the CT imaging system 100 is configured to image a patient 110. In an exemplary embodiment, the CT imaging system 100 includes a gantry 102, which in turn, may further include at least one X-ray source (not shown) configured to emit a beam of X-ray radiation for use in imaging the patient 110 laying on a table 104 of the CT imaging system. The gantry 102 includes a bore or opening 106 extending through the center of the gantry 102. The X-ray source is configured to project an X-ray radiation beam towards an X-ray detector array (not shown) positioned directly opposite from the X-ray source in the gantry 102.

In some CT imaging system configurations, an X-ray source emits a cone-shaped X-ray radiation beam which is collimated to lie within an x-y-z plane of a Cartesian coordinate system and is generally referred to as an “imaging plane.” The X-ray radiation beam passes through the patient being imaged. The X-ray radiation beam, after being attenuated by the patient, is received by the X-ray detector array. The intensity of the attenuated X-ray radiation beam received at the X-ray detector array is dependent upon the attenuation of the X-ray radiation beam by the patient.

In some CT imaging systems, the X-ray source and the X-ray detector array are rotated within the gantry and around the patient being imaged creating an imaging plane, such that an angle at which the X-ray radiation beam intersects the patient constantly changes. A plurality of X-ray radiation attenuation measurements, e.g., projection data, from the X-ray detector array at any one gantry angle is referred to as a “view.” A “scan” of the patient includes a set of views made at different gantry angles, or view angles, during one revolution of the X-ray source and X-ray detector array. As used herein the term “view” is not limited to the use as described above with respect to projection data from one gantry angle, but the term “view” is used to mean one data acquisition whenever there are multiple data acquisitions from different angles, whether from a CT imaging system, and/or any other imaging system, including imaging systems yet to be developed as well as combinations thereof.

Specifically, FIG. 1 illustrates a schematic perspective view of an exemplary embodiment of a CT imaging system 100 with a patient isolation unit 120 positioned relative to the CT imaging system and removably coupled to the table 104 to isolate a patient 110 from an imaging room and the CT imaging system by enclosing the patient 110 within the patient isolation unit 120 that is specifically intended for use with the CT imaging system.

The patient isolation unit 120 completely covers and contains the patient 110 therein. In the exemplary embodiment of FIG. 1, the patient isolation unit 120 includes a base 122, a pad 124 placed on top of the base 122, a first end wall 126 extending from a first end 121 of the base 122 near the patient’s feet, a second end wall 128 extending from a second end 123 of the base 122 near the patient’s head, and a semi-cylindrical cover 129 that extends from a first side 125 of the base 122 to a second side 127 of the base 122 and between the first end wall 126 and the second end wall 128 to completely enclose the patient 110 therein. The first end 121 of the base 122 is positioned directly opposite from the second end 123 of the base 122. The patient isolation unit 120 providing containment of the patient 110 in a desired position, such as a supine position. The base 122, first end wall 126, second end wall 128, and cover 129 may be made of a rigid material, a semi-rigid material, or a flexible material. Further, the base 122, first end wall 126, second end wall 128, and cover 129 mate with one another in a sealed configuration such that no pathogens may escape from the patent isolation unit 120 when a patient is enclosed within the patent isolation unit 120. The patient isolation unit 120 is generally comprised of a pathogen impermeable material compatible with one or more of radiation imaging systems and/or magnetic resonance (MR) imaging systems.

The patient isolation unit 120 is generally sized to provide for placement into the bore 106 of the gantry 102 of the CT imaging system 100. More particularly, the patient isolation unit 120 is preferably sized to provide placement into the bore 106 and within a field of view (FOV) of the CT imaging system. For example, in an embodiment, the gantry 102 of the CT imaging system may have a bore diameter of approximately 70 cm, may include a FOV diameter of approximately 50 cm, and provide for placement of a patient isolation unit 120 therein having a diameter of approximately 45 cm. In addition, the patient isolation unit 120 may be sized to permit placement of the patient’s arms in an over-head position when specific imaging requires such, as shown in FIG. 1. Alternatively, if portions of the patient isolation unit 120 are not within the FOV, or if an oversized patient isolation unit 120 is provided to accommodate large patients, image reconstruction algorithms may be employed to correct or compensate for all or portions of the patient isolation unit 120 and/or patient that may be outside the FOV.

In an exemplary embodiment, an optional cart 130 may be used to provide transport of the patient isolation unit 120 to and from the medical imaging room or suite, and to dock or permit placement of the patient isolation unit 120 on the table 104 of the CT imaging system. To eliminate risk of contaminating the CT imaging system and the imaging suite, a patient may be transferred from a bed or a gurney to the base 122 of the patient isolation unit 120 that may be positioned on the cart 130 and enclosed within the patient isolation unit 120. To provide placement of the patient isolation unit 120 on the CT imaging system table 104, the cart 130 may generally include a U-shaped cart base 132 and at least one structural member 134 attached to the cart base 132 that supports the patient isolation unit 120 and allows the cart 130 with the patient isolation unit 120 coupled thereto to approach the CT imaging system table 104 from the side and rotate around the table 104 as indicated by arrow 136 in FIG. 1. Alternatively, if sufficient room permits, the cart 130 with the patient isolation unit 120 coupled thereto may approach the table 104 straight on as indicated by arrow 138 in FIG. 1. The cart 130 may be configured in a left or right hand version with at least one structural member 134 attached to one side of the cart base 132 to accommodate multiple imaging room layouts. The CT imaging system table 104 is positioned to provide for placement of the patient isolation unit 120 over the table 104, such that when the table 104 is raised to the operable position, the patient isolation unit 120 is lifted off of the structural member 134 and positioned on top of the table 104. Once this occurs, the cart 130 may be moved away from the table 104. In an exemplary embodiment, the cart 130 may be optimized for specific imagining equipment, e.g., non-magnetic for MR imaging systems. Furthermore, in another exemplary embodiment, the cart 130 may be constructed such that it is modular and can be readily converted between left and right hand configurations in order to accommodate different imaging room configurations in the same healthcare facility.

In contrast to known patient isolation units, the disclosed novel patient isolation unit 120 is configured for use with one or more types of medical imaging systems. Although a CT imaging system is shown and described by way of example in FIG. 1, it should be understood that the patient isolation unit may also be used with other imaging systems, such as an X-ray imaging system, a CT imaging system , a positron emission tomography (PET) imaging system, a single-photon emission computerized tomography (SPECT) imaging system, a MR imaging system, and combinations thereof (e.g., multi-modality imaging systems, such as PET/CT, PET/MR or SPECT/CT imaging systems). The present discussion of a CT imaging system is provided merely as an example of one suitable imaging modality. The patient isolation unit provides isolation of the patient from the surrounding imaging system, imaging room or suite, operators, technologists, nursing aids, nurses, physicians and/or other healthcare professionals.

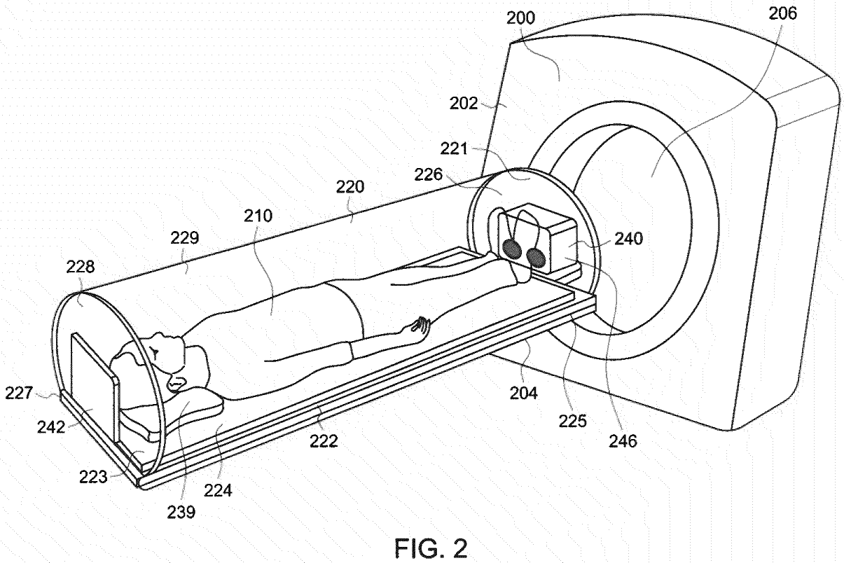

FIG. 2 illustrates a schematic perspective view of another embodiment of a patient isolation unit 220 coupled to and positioned relative to a medical imaging system 200 table 204. The medical imaging system includes a gantry 202, a table, and a bore or opening 206 extending through the gantry 202. The patient isolation unit 220 completely covers and contains a patient 210 therein. The patient isolation unit 220 includes a base 222, a pad 224 positioned on top of the base 222, a pillow 239 positioned on top of the base 222 near a second end 223 of the base 222 near the patient’s head, a first end wall 226 extending from a first end 221 of the base 222 near the patient’s feet, a second end wall 228 extending from a second end 223 of the base 222 near the patient’s head, and a semi-cylindrical cover 229 that extends from a first side 225 of the base 222 to a second side 227 of the base 222 and between the first end wall 226 and the second end wall 228 to completely enclose the patient 210 therein. The first end 221 of the base 222 is positioned directly opposite from the second end 223 of the base 222. The patient isolation unit 220 providing containment of the patient 210 in a desired position, such as a supine position. The base 222, first end wall 226, second end wall 228, and cover 229 may be made of a rigid material, a semi-rigid material, or a flexible material. Further, the base 222, first end wall 226, second end wall 228, and cover 229 mate with one another in a sealed configuration such that no pathogens may escape from the patent isolation unit 220 when a patient is enclosed within the patent isolation unit 220. The patient isolation unit 220 is generally comprised of a pathogen impermeable material. The patient isolation unit 220 is generally sized to provide for placement into the bore 206 of the gantry 202 of the medical imaging system 200.

In an exemplary embodiment, the first and second end walls 226, 228 may have a semi-cylindrical shape or a U-shape. The base 222 may be shaped having a substantially planar profile or non-planar profile, such as by forming a recess along a length to aid in patient positioning and comfort. In addition, for patient comfort, a low profile pad 224, and/or a pillow 239, may be positioned relative to the base 222, such as in a pocket, or the like, to provide positioning of the patient. In an exemplary embodiment, the base 222 and first and second end walls 226, 228 may be formed of any rigid material suitable for placement within the medical imaging system, such as, but not limited to a carbon fiber material, a polycarbonate material, and more specifically, a polycarbonate resin thermoplastic, such as Lexan^{®}, or the like. In an exemplary embodiment, the cover 229 may be formed of any suitable pathogen impermeable material, such as a biochemically resistive material. In an exemplary embodiment, a flexible cover may be formed of polyethylene, polyurethane, polyvinyl chloride (vinyl), or the like. In one particular embodiment, a flexible cover may be formed of a vinyl material, such as a 40 mil thick vinyl material. In alternative embodiments, the cover may be configured as a semi-rigid cover, such as with a removable roller shutter-like cover that rolls up, a foldable cover in the style of accordion bellows when the patient enters/exits the patient isolation unit, or the like, or as a rigid cover that is physically positioned over the patient in sealing engagement with a base. As an example, a patient isolation unit including a semi-rigid or rigid cover may be formed of a 50-100 mil polycarbonate or acrylic material that is bonded to rigid ends at each end, or a monolithically formed cover that is, in essence, a semicircular cylinder with closed ends. In an exemplary embodiment, at least a portion of the cover is transparent to enable visual contact with the patient contained therein.

To provide for ease in patient access during use, the cover may be at least partially removed from the end and base. In an exemplary embodiment, the cover may be completely detached and removed from the plurality of end walls and the base. Subsequent to positioning of the patient on the base, between the first and second end walls, the cover may be reattached to the end walls and base to provide for a substantially enclosing of the patient therein the patient isolation unit.

In an exemplary embodiment, the end walls may be coupled to the base or integrally formed therewith, and provide for at least partial, if not complete, uncoupling of the end walls and/or flexible cover therefrom. Uncoupling of the cover and/or end walls facilitates transfer of a patient to and from the patient isolation unit. In an exemplary embodiment, the cover may be coupled to the end walls and the base utilizing strips of hook and loop fasteners (Velcro®), rubber zippers, or any known non-metallic fastener, suitable to provide a substantially airtight seal, and compatible for use in an imaging system.

The patient isolation unit 220 may be configured as a self-contained system that may further include an air filtration system 240 that may be configured to supply filtered air to the interior of the patient isolation unit 220 and filter exhaust air out to the exterior of the patient isolation unit 220.

In an exemplary embodiment, the patient isolation unit 220 includes an air filtration system 240 with an air intake filter 242 positioned at and coupled to a first end 221 of the patient isolation unit 220, an air exhaust filter (not shown) positioned at and coupled to a second end 223 of the patient isolation unit 220, and an air pump 226 coupled to the patient isolation unit 220. The air pump 226 may be battery operated or powered by one or more batteries.

The air filtration system 240 is configured to supply fresh or clean air to the patient isolation unit 220 and exhaust filtered air from the patient isolation unit 220. The air pump 246 may be operated in a suction mode to provide negative air pressure within the patient isolation unit 220 and maintain any pathogens inside the patient isolation unit 220 when used in conjunction with patients having an infectious disease. In an alternate embodiment, the air pump 246 may be operated in a pump mode to provide positive air pressure within the patient isolation unit 220 to prevent pathogens outside of the patient isolation unit from entering the patient isolation unit 220 when scanning a non-infected patient in a potentially contaminated imaging suite or during transport. It should be noted that differential impedance values at the intake and exhaust components of the air pump 246 may be required based on the desired negative or positive pressure within the patient isolation unit 220, and that air filters may be required on either the intake or exhaust, based on the objective to isolate a potentially infected patient from a non-contaminated imaging room, or to isolate a non-infected patient from a potentially infected imaging room. The air pump 246 may be battery operated and include replaceable filters. In an exemplary embodiment, the air filter(s) 242 and the air pump 246 may be located proximate the first and/or second end walls 226, 228 having formed therethrough air ports or openings to accommodate the input/exhaust of air. Additional patient environment controls may be included, such as temperature and humidity. In an exemplary embodiment, the air filtration system 240 may be a closed-loop system, where air never enters or leaves a closed-loop airflow reservoir. In addition, the patient isolation unit 220 may include one or more communication devices, such as a microphone, a speaker, or the like, to provide communication with the patient enclosed within the patient isolation unit 220 during transport and/or imaging.

Subsequent to use, the patient isolation unit 220 may be disinfected as dictated by specific pathogen contamination, such as by using hydrogen peroxide (H₂O₂) fogging or similar cleaning technology. In addition, ultraviolet (UV) light may be used to inactivate pathogens on the patient isolation unit 220. As used herein, the term “inactivate” refers to rendering a pathogen inactive, or unable to infect a human being. This may include killing pathogens, rendering them unable or less able to replicate, or rendering them unable to infect human beings. The cover may be completely detached or removed for cleaning and/or disinfecting, and, if a flexible cover, laid flat. In an exemplary embodiment, a specialized cleaning station may automatically disinfect the patient isolation unit 220, potentially cleaning multiple patient isolation units at the same time (e.g., vaporized H₂O₂ or UV light disinfecting systems may be used in a “cleaning room”). In MR imaging systems, cleaning of the imaging table and gantry is particularly difficult, as non-magnetic cleaning equipment is required. Use of the patient isolation unit 220 as disclosed herein allows for the cleaning/disinfecting outside of the magnetic field.

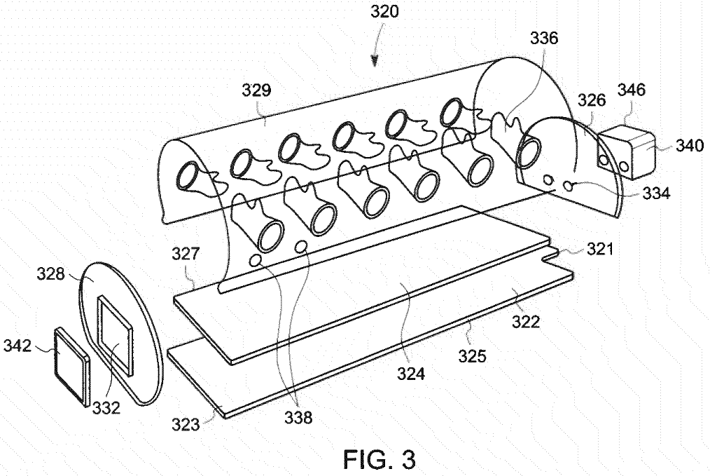

FIG. 3 illustrates an exploded schematic perspective view of yet another embodiment of a patient isolation unit 320. The patient isolation unit 320 includes a base 322, a pad 324 positioned on top of the base 322, a first end wall 326 extending from a first end 321 of the base 322 near the patient’s feet, a second end wall 328 extending from a second end 323 of the base 322 near the patient’s head, and a semi-cylindrical cover 329 that extends from a first side 325 of the base 322 to a second side 327 of the base 322 and between the first end wall 326 and the second end wall 328 to completely enclose a patient therein. The first end 321 of the base 322 is positioned directly opposite from the second end 323 of the base 322. The patient isolation unit 320 providing containment of a patient in a desired position, such as a supine position. The base 322, first end wall 326, second end wall 328, and cover 329 may be made of a rigid material, a semi-rigid material, or a flexible material. Further, the base 322, first end wall 326, second end wall 328, and cover 329 mate with one another in a sealed configuration such that no pathogens may escape from the patent isolation unit 320 when a patient is enclosed within the patent isolation unit 320. The patient isolation unit 320 is generally comprised of a pathogen impermeable material.

In an exemplary embodiment, the patient isolation unit 320 may include an air filtration system 340 with an air intake filter 342 positioned at and coupled to a first end 321 of the patient isolation unit 320, and an air pump 326 positioned at and coupled to a second end 321 of the patient isolation unit 320. The air filtration system 340 is configured to supply fresh or clean air to the patient isolation unit 320 and exhaust filtered air from the patient isolation unit 320. The air pump 346 may be operated in a suction mode to provide negative air pressure within the patient isolation unit 320 and maintain any pathogens inside the patient isolation unit 320 when used in conjunction with patients having an infectious disease. In an alternate embodiment, the air pump 346 may be operated in a pump mode to provide positive air pressure within the patient isolation unit 320 to prevent pathogens outside of the patient isolation unit from entering the patient isolation unit 320 when scanning a non-infected patient in a potentially contaminated imaging suite or during transport. It should be noted that differential impedance values at the intake and exhaust components of the air pump 346 may be required based on the desired negative or positive pressure within the patient isolation unit 320, and that air filters may be required on either the intake or exhaust, based on the objective to isolate a potentially infected patient from a non-contaminated imaging room, or to isolate a non-infected patient from a potentially infected imaging room. The air pump 346 may be battery operated and include replaceable filters. In an exemplary embodiment, the air filter 342 and the air pump 346 may be located proximate the first and/or second end walls 326, 328 having formed therethrough air ports or openings 332, 334 to accommodate the input and/or exhaust of air. In an exemplary embodiment, the air filtration system 340 may be a closed-loop system, where air never enters or leaves a closed-loop airflow reservoir.

In an exemplary embodiment, to provide for ease in patient access during use, the patient isolation unit 320 may include optional and/or alternative covers that provide for intravenous (IV) lines, IV contrast agent lines, and one or more built in gloves 336 formed along a length of the cover 329. Alternatively, one or more IV or contrast lines ports 338 may be provided at one or more of the ends 321, 323.

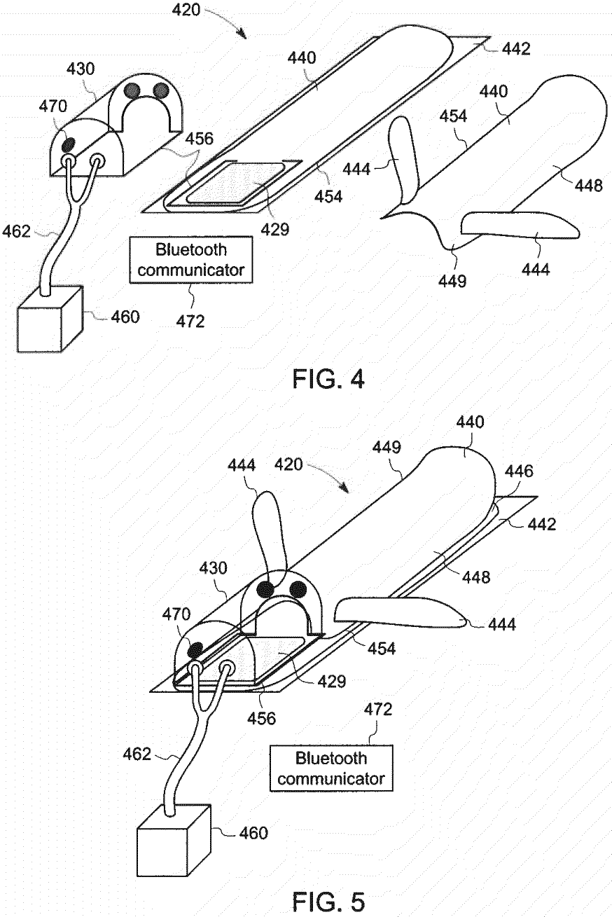

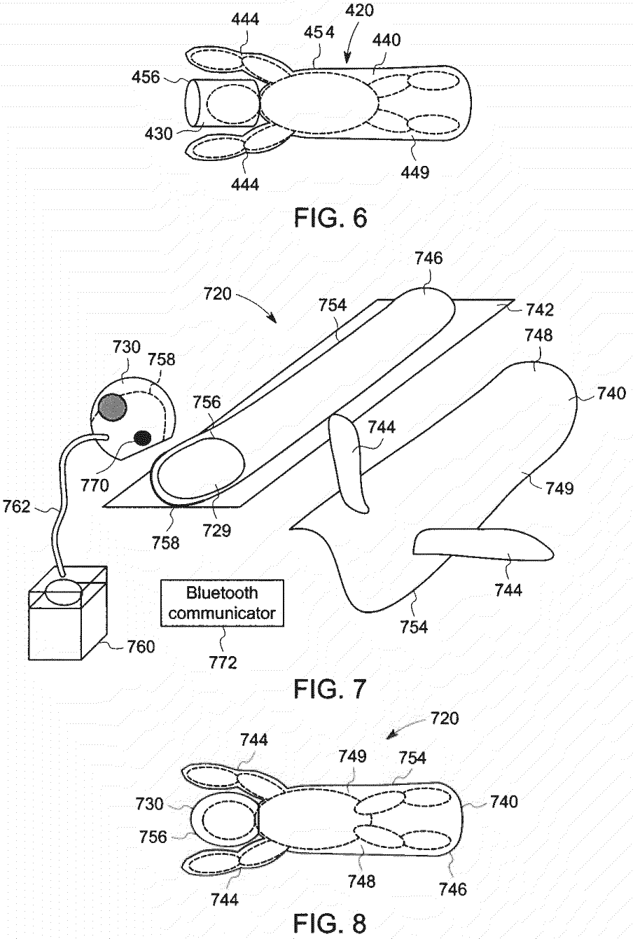

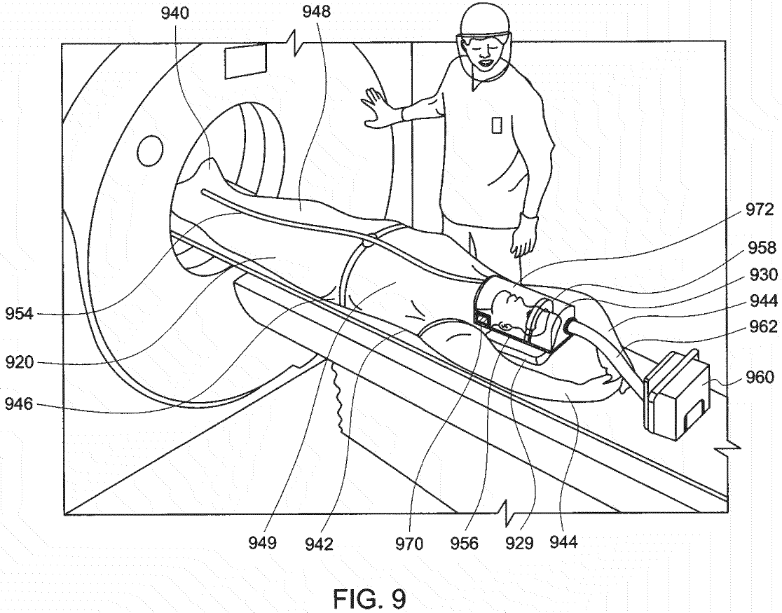

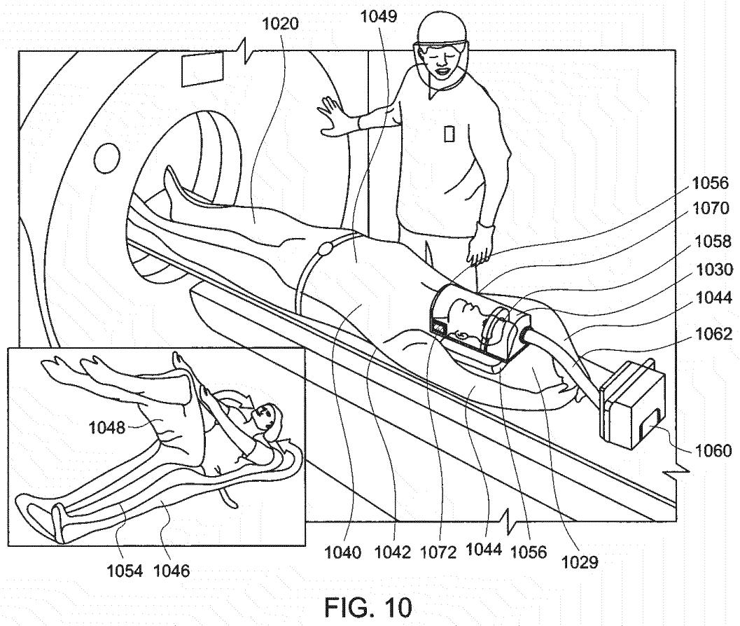

Exemplary embodiments of patient isolation units are illustrated in FIGS. 4-10. The patient isolation units are generally similar to the previous embodiments, but include separate patient head and body enclosures. FIGS. 4, 5 and 6 illustrate a schematic view of another embodiment of a patient isolation unit 420. FIG. 5 illustrates a schematic perspective view of the embodiment of the patient isolation unit 420 of FIG. 4 in an assembled state. FIG. 6 illustrates a schematic top view of the embodiment of the patient isolation unit 420 of FIG. 5. FIGS. 7 and 8 illustrate a schematic view of another embodiment of a patient isolation unit 720. FIG. 8 illustrates a schematic top view of the embodiment of the patient isolation unit 720 of FIG. 7. FIG. 9 illustrates a schematic perspective view of another embodiment of a patient isolation unit 920, similar to that of FIGS. 4-8, coupled to and positioned relative to a medical imaging system 900. FIG. 10 illustrates a schematic perspective view of another embodiment of a patient isolation unit 1020 coupled to and positioned relative to a medical imaging system 1000.

More particularly, as illustrated in FIGS. 4-10, the patient isolation units 420, 720, 920, 1020 may include a head enclosure 430, 730, 930, 1030 and a body enclosure 440, 740, 940, 1040 provided for enclosing a patient therein. The head enclosure 430, 730, 930, 1030 may be a semi-cylindrical or spherical head enclosure that may be configured for placement about a patient’s head. The body enclosure 440, 740, 940, 1040 may be configured for placement about a patient’s arms and body, especially configured to accommodate positioning of a patient’s arms in an extended position above and proximate the head. The patient’s arms and body are enclosed within a flexible cover 449, 749, 949, 1049 such as a bag or body-like structure, that is coupled together to enclose a patient’s arms and body therein. The flexible cover 449, 749, 949, 1049 may be coupled to a base 442, 742, 942, 1042. In an exemplary embodiment, the flexible cover 449, 749, 949, 1049 may include sleeve members 444, 744, 944, 1044 to accommodate the patient’s arms and provide for flexibility in positioning in the arms above the head. The body enclosure 430, 730, 930, 1030 includes the at least two sleeve members 444, 744, 944, 1044 extending from the body enclosure to accommodate a patient’s arms therein. In an alternate embodiment, the flexible cover 449, 749, 949, 1049 may include separated leg members (not shown). In an exemplary embodiment, the flexible cover 449, 749, 949, 1049 may be configured without a base, such as previously described, or a flexible bottom portion, about a substantial perimeter of the flexible cover. In an alternate embodiment, the flexible cover 449, 749, 949, 1049 may include a centrally located zipper, or other type of a first fastening mechanism 454, 754, 954, 1054 to facilitate positioning of a patient within the patient isolation unit. In an exemplary embodiment, the flexible cover 449, 749, 949, 1049 may include a bottom member 446, 746, 946, 1046 that may be coupled to a base 442, 742, 942, 1042 and a top member 448, 748, 948, 1048 that includes the sleeve members 444, 744, 944, 1044 and first fastening mechanism 454, 754, 954, 1054 to couple the bottom member 446, 746, 1046, 1146 to the top member 448, 748, 948, 1048, and to permit placing a patient within the body enclosure while the patient is in a supine position.

The head enclosure 430, 730, 930, 1030 may be coupled to the body enclosure 440, 740, 940, 1040 with a second fastening mechanism 456, 756, 956, 1056 and include a head holding member 458, 758, 958, 1058 to hold the head enclosure 430, 730, 930, 1030 on a patient’s head. The head holding member 458, 758, 958, 1058 may include a strap made of flexible plastic, an elastic band, or the like, spanning across the patient’s forehead and coupled to the head enclosure; a foam pad coupled to the head enclosure and located so as to be in contact or in close proximity to the patient’s head; a loop such as is provided with a hard hat or bicycle helmet, which is attached to the head enclosure and fully or partially encompasses the top of the patient’s head; or the like. In an exemplary embodiment, the patient isolation unit 420, 720, 920, 1020 may include a pad or pillow 429, 729, 929, 1029 positioned on top of the base 442, 742, 942, 1042 near where the head of the patient would be positioned.

In an exemplary embodiment, the head enclosure 430, 730, 930, 1030 may be coupled to an air filtration system 460, 760, 960, 1060. The air filtration system 460, 760, 960, 1060 may be coupled to the head enclosure 430, 730, 930, 1030 with at least one air hose 462, 762, 962, 1062, and may be attached to a transport gurney, cart, or the like.

In an exemplary embodiment, the patient isolation unit 420, 720, 920, 1020 may include a wired or wireless communication system 470, 770, 970, 1070 to provide communication with the patient enclosed within the patient isolation unit during transport and imaging. The communication system 470, 770, 970, 1070 may include a microphone, a speaker, or the like, to provide communication with the patient enclosed within the patient isolation unit during transport and/or imaging. In an exemplary embodiment, the communication system 470, 770, 970, 1070 may be wired or in the alternative may be wireless, such as a Bluetooth enabled communication system 472, 772, 972, 1072.

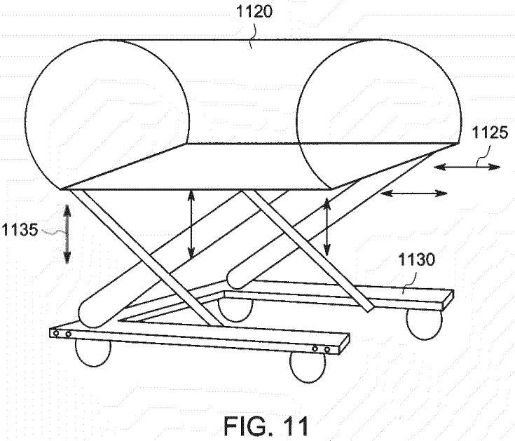

FIG. 11 illustrates a schematic perspective view of yet another embodiment of a patient isolation unit 1120 positioned on and coupled to a cart 1130. The cart 1130 having a fixed base 1132 and a plurality of moveable structural members 134 coupled to the fixed base 1132. For imaging systems using a docking table (a patient table that is separable from the imaging system and is mobile but can be docked to the imaging system for scanning), the patient isolation unit 1120 may be integrated into the docking table itself or transported to an imaging system table by a cart 1130. Multiple such tables could then be used with the same gantry to enhance productivity. More particularly, the patient isolation unit 1120 may be configured as a quasi-cylindrical pathogen shield that includes a mobile cart 1130. During use, the cart position may be controlled by various controls (not shown) to provide movement of the cart 1130 in multiple dimensions by movement of the plurality of moveable structural members 134 as identified as arrows 1125, 1135 in FIG. 11, to position and dock the patient isolation unit 1120 relative to the imaging system or imaging system table.

Accordingly disclosed is a patient isolation unit that provides containment of pathogens therein, or isolation from pathogens in a surrounding environment, during medical imaging procedures. The patient isolation unit may be configured to isolate a patient with an infectious disease from a surrounding environment in the imaging suite, or vice versa, to isolate a patient from infections pathogens that may be present in the imaging suite. The novel patient isolation unit is comprised of materials compatible with radiation imaging and MR imaging (e.g., no metal or other dense objects), of appropriate dimension for substantially all imaging systems, and with a means to conveniently transfer substantially all patients to and from the patient isolation unit, and to and from the imaging system, in most or all healthcare facilities with the assistance of typical healthcare personnel. The patient isolation unit includes a filtered air filtration system that provides for a negative air pressure within the patient isolation unit and air filters to ensure no pathogen escapes the patient isolation unit to contaminate the imaging system or imaging suite, or a positive air pressure within the patient isolation unit to prevent pathogens outside of the patient isolation unit from entering the patient isolation unit when scanning a non-infected patient in a potentially contaminated imaging suite. The patient isolation unit may include features to provide for patient needs while imaging, such as optional gloves and/or optional provision for IV lines, contrast agent lines, or the like.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

While the present disclosure has been described with reference to one or more drawings and exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Furthermore, the skilled artisan will recognize the interchangeability of various features from different embodiments. For example, various features described, as well as other known equivalents for each feature, may be mixed and matched by one of ordinary skill in this art to construct additional systems and techniques in accordance with principles of this disclosure. Therefore, it is intended that the disclosure not be limited to the particular embodiments disclosed as the best mode. This written description uses examples to disclose the invention, including the best mode, and also to enable any person skilled in the art to practice the invention, including making and using any devices or systems and performing any incorporated methods.

Embodiments of the present disclosure shown in the drawings and described above are example embodiments only and are not intended to limit the scope of the appended claims, including any equivalents as included within the scope of the claims. Various modifications are possible and will be readily apparent to the skilled person in the art. It is intended that any combination of non-mutually exclusive features described herein are within the scope of the present invention. That is, features of the described embodiments can be combined with any appropriate aspect described above and optional features of any one aspect can be combined with any other appropriate aspect. Similarly, features set forth in dependent claims can be combined with non-mutually exclusive features of other dependent claims, particularly where the dependent claims depend on the same independent claim. Single claim dependencies may have been used as practice in some jurisdictions require them, but this should not be taken to mean that the features in the dependent claims are mutually exclusive.

What is claimed is:

1. A patient isolation unit, comprising:
an enclosure comprised of a pathogen impermeable material compatible with one or more imaging systems; and
an air filtration system coupled to the enclosure;
wherein the air filtration system includes an inlet to supply filtered air to an interior of the enclosure and an outlet to exhaust filtered air to an exterior of the enclosure.

2. The patient isolation unit of claim 1, wherein the enclosure includes:
a base;
a first end wall coupled to a first end of the base;
a second end wall coupled to a second end of the base; and
a cover coupled to a first side of the base, a second side of the base, the first end wall and the second end wall for substantially enclosing a patient therein between the base, the first end wall, and the second end wall for use on a medical imaging system.

3. The patient isolation unit of claim 2, wherein the enclosure further includes a pad positioned on top of the base.

4. The patient isolation unit of claim 1, wherein the enclosure is made of a flexible material.

5. The patient isolation unit of claim 1, wherein the enclosure is made of a semirigid material.

6. The patient isolation unit of claim 1, wherein the enclosure is made of a rigid material.

7. The patient isolation unit of claim 1, wherein the enclosure is configured to fit into a bore of a medical imaging system.

8. The patient isolation unit of claim 2, wherein the base, the first end wall, the second end wall, and the cover mate with one another in a sealed configuration.

9. The patient isolation unit of claim 1, wherein the enclosure is made of a pathogen impermeable material.

10. The patient isolation unit of claim 1, wherein the enclosure has a semi-cylindrical shape.

11. The patient isolation unit of claim 1, wherein the air filtration system includes an air intake filter positioned at and coupled to a first end of the enclosure.

12. The patient isolation unit of claim 11, wherein the air filtration system further includes an air exhaust filter positioned at and coupled to a second end of the enclosure.

13. The patient isolation unit of claim 12, wherein the air filtration system further includes an air pump coupled to the enclosure.

14. The patient isolation unit of claim 13, wherein the air pump is battery powered.

15. The patient isolation unit of claim 2, wherein the cover includes a plurality of built-in gloves formed along the length of the cover.

16. A system, comprising:
a base;
a first end wall coupled to a first end of the base;
a second end wall coupled to a second end of the base; and
a cover coupled to a first side of the base, a second side of the base, the first end wall and the second end wall for substantially enclosing a patient therein between the base, the first end wall, and the second end wall for use on a medical imaging system.

17. The system of claim 16, further comprising a cart to provide transport of the system to an imaging system.

18. A patient isolation unit, comprising:
a head enclosure comprised of a pathogen impermeable material compatible with one or more imaging systems; and
a body enclosure coupled to the head enclosure and comprised of a pathogen impermeable material compatible with one or more imaging systems.

19. The patient isolation unit of claim 18, wherein the body enclosure includes sleeve members extending from the body enclosure to accommodate a patient’s arms therein.

20. The patient isolation unit of claim 18, further comprising an air filtration system coupled to the head enclosure.
